(19) United States
(12) Patent Application Publication
(10) Pub. No.: US 2019/0027770 A1
(43) Pub. Date: Jan. 24, 2019

(54) REDOX FLOW BATTERY, ELECTRODE FOR REDOX FLOW BATTERY, AND ELECTRODE CHARACTERISTIC EVALUATION METHOD

(71) Applicant: Sumitomo Electric Industries, Ltd., Osaka-shi (JP)

(72) Inventors: Kosuke Shiraki, Osaka-shi (JP); Takashi Kanno, Osaka-shi (JP); Takefumi Ito, Osaka-shi (JP); Masahiro Kuwabara, Osaka-shi (JP); Hideyuki Yamaguchi, Osaka-shi (JP); Hayato Fujita, Osaka-shi (JP); Kiyoaki Hayashi, Osaka-shi (JP); Kiyoaki Moriuchi, Osaka-shi (JP)

(21) Appl. No.: 16/068,160

(22) PCT Filed: Jan. 7, 2016
(86) PCT No.: PCT/JP2016/050405

§ 371 Date: Jul. 5, 2018

(51) Int. Cl. H01M 8/18; H01M 4/04; H01M 10/04

(52) U.S. Cl. CPC H01M 8/18; H01M 10/049; H01M 10/0431; H01M 4/0447

(57) ABSTRACT

Provided are a redox flow battery having a low internal resistance, an electrode used in a redox flow battery, and an electrode characteristic evaluation method with which a characteristic of an electrode can be simply and accurately evaluated. The redox flow battery includes at least one pair of electrodes in a stacked manner, the electrodes including a positive electrode and a negative electrode to which an electrolyte is supplied and in which a battery reaction is performed. In the redox flow battery, a total area of the electrodes is 40,000 cm² or more, and a sticking ratio is 1% or more, the sticking ratio being a value determined by, in a state in which a sample taken from an arbitrary position of the stacked electrodes and having a predetermined size is horizontally placed, dropping a predetermined amount of pure water from above the sample, vertically placing the sample on which the pure water has been dropped, subsequently measuring a mass of the sample, and dividing an amount calculated by subtracting, from the measured value, a mass of the sample before the dropping by a mass of the dropped pure water.

### TECHNICAL FIELD

The present invention relates to a redox flow battery, which is one of storage batteries, an electrode used in a redox flow battery, and a method for evaluating a characteristic of an electrode used in a storage battery such as a redox flow battery. In particular, the present invention relates to a redox flow battery having a low internal resistance, and an electrode characteristic evaluation method with which a characteristic of an electrode used in a storage battery such as a redox flow battery can be simply evaluated.

### BACKGROUND ART

One of storage batteries is a redox flow battery (hereinafter, may be referred to as an “RF battery”) in which a battery reaction is performed by supplying electrolytes to electrodes. The RF battery has features such as (1) ease of output increase and capacity increase to a megawatt level (MW level), (2) a long life, (3) capability of accurately monitoring the state of charge (SOC) of the battery, and (4) high design freedom due to capability of independently designing battery output and battery capacity, and is expected to be suitable for a storage battery for stabilization of power systems.

An RF battery typically includes, as a main component, a battery cell including a positive electrode to which a positive electrode electrolyte is supplied, a negative electrode to which a negative electrode electrolyte is supplied, and a membrane disposed between the two electrodes. A fiber fabric formed of carbon fibers, such as carbon felt, (PTL 1) is used as the positive electrode and the negative electrode.

One of characteristics required for a storage battery such as an RF battery is a low internal resistance. PTL 1 discloses that a cell resistance can be reduced by subjecting a fiber fabric to a hydrophilic treatment such as a heat treatment, a laser treatment, or an ion implantation method, compared with the untreated case.

### CITATION LIST

### Patent Literature

PTL 1: Japanese Unexamined Patent Application Publication No. 2001-028268

### SUMMARY OF INVENTION

### Technical Problem

However, even an electrode that has been subjected to a hydrophilic treatment (hereinafter, may be referred to as an “electrode after treatment”) may have a high internal resistance as shown in a test example described below. Accordingly, it is desirable to provide a redox flow battery (RF battery) whose internal resistance can be more reliably reduced, and an electrode capable of more reliably constructing an RF battery having a low internal resistance.

One of the possible reasons why even an electrode after treatment has a high internal resistance is that the hydrophilized state is not appropriately maintained. Even in the case where a hydrophilic treatment is performed under the same conditions, a change in the hydrophilized state may occur during, for example, the storage or transportation of the electrode after treatment. In particular, a high-output redox flow battery includes a large number of electrodes (includes a plurality of pairs of positive electrodes and negative electrodes) or includes electrodes having a relatively large area. Therefore, an electrode that is in an inappropriate hydrophilized state may be included in a plurality of electrodes, or a region that is in an inappropriate hydrophilized state (locally degraded region) may be included in one electrode. If it is possible to determine whether or not hydrophilicity of electrodes is good, for example, immediately before the assembly of an RF battery and the RF battery is assembled by using only non-defective electrodes, an RF battery having a low internal resistance can be more reliably constructed. However, no method capable of easily evaluating hydrophilicity of an electrode has not hitherto been studied.

PTL 1 discloses that the number of oxygen atoms and the number of carbon atoms of an electrode after treatment are measured by X-ray photoelectron spectroscopy, an R value of the electrode after treatment is measured by Raman spectroscopic analysis, and conditions for a hydrophilic treatment are adjusted such that a ratio of the number of oxygen atoms to the number of carbon atoms and the R value fall within specific ranges. X-ray photoelectron spectroscopy and Raman spectroscopic analysis take time because, for example, a sample is placed in a dedicated device. When a plurality of electrodes are examined, it is necessary to place samples in the dedicated device one by one, which takes more time. Furthermore, in general, these analysis costs are high, resulting in an increase in the cost. Accordingly, with regard to an electrode used in a storage battery such as an RF battery, it is desirable that an electrode characteristic such as hydrophilicity can be simply evaluated.

The present invention has been made in view of the circumstances described above. An object of the present invention is to provide a redox flow battery having a low internal resistance and an electrode for a redox flow battery, the electrode being capable of constructing a redox flow battery having a low internal resistance.

Another object of the present invention is to provide an electrode characteristic evaluation method with which a characteristic of an electrode used in a storage battery such as a redox flow battery can be simply and accurately evaluated.

### Solution to Problem

An electrode characteristic evaluation method according to an embodiment of the present invention is an electrode characteristic evaluation method for evaluating a characteristic of an electrode used in a storage battery including an electrolyte, the method including

a step of, in a state in which a sample taken from the electrode and having a predetermined size is horizontally placed, dropping a predetermined amount of pure water from above the sample; and

a step of vertically placing the sample on which the pure water has been dropped, and subsequently measuring a mass of the sample to examine an amount of the pure water stuck to the sample.

A redox flow battery according to an embodiment of the present invention is a redox flow battery including at least one pair of electrodes in a stacked manner, the electrodes including a positive electrode and a negative electrode to which an electrolyte is supplied and in which a battery reaction is performed,

in which a total area of the electrodes is 40,000 cm² or more, and

a sticking ratio is 1% or more, the sticking ratio being a value determined by, in a state in which a sample taken from an arbitrary position of the stacked electrodes and having a predetermined size is horizontally placed, dropping a predetermined amount of pure water from above the sample, vertically placing the sample on which the pure water has been dropped, subsequently measuring a mass of the sample, and dividing an amount calculated by subtracting, from the measured value, a mass of the sample before the dropping by a mass of the dropped pure water.

An electrode for a redox flow battery according to an embodiment of the present invention is an electrode for a redox flow battery, the electrode being used in a redox flow battery to which an electrolyte is supplied and in which a battery reaction is performed,

in which the electrode has an area of 500 cm² or more, and

a sticking ratio is 1% or more, the sticking ratio being a value determined by, in a state in which a sample taken from an arbitrary position of the electrode and having a predetermined size is horizontally placed, dropping a predetermined amount of pure water from above the sample, vertically placing the sample on which the pure water has been dropped, subsequently measuring a mass of the sample, and dividing an amount calculated by subtracting, from the measured value, a mass of the sample before the dropping by a mass of the dropped pure water.

### Advantageous Effects of Invention

According to the electrode characteristic evaluation method, a characteristic of an electrode used in a storage battery can be simply and accurately evaluated.

The redox flow battery has a low internal resistance.

According to the electrode for a redox flow battery, a redox flow battery having a low internal resistance can be constructed.

### BRIEF DESCRIPTION OF DRAWINGS

FIG. 1 is a diagram illustrating a basic configuration and a basic operating principle of a redox flow battery system including a redox flow battery of Embodiment 1.

FIG. 2 is a schematic view illustrating a configuration of an example of a cell stack included in a redox flow battery of Embodiment 1.

### DESCRIPTION OF EMBODIMENTS

### Description of Embodiments of the Present Invention

First, the contents of embodiments of the present invention will be listed and described.

(1) An electrode characteristic evaluation method according to an embodiment of the present invention is an electrode characteristic evaluation method for evaluating a characteristic of an electrode used in a storage battery including an electrolyte, the method including

a step of, in a state in which a sample taken from the electrode and having a predetermined size is horizontally placed, dropping a predetermined amount of pure water from above the sample; and

a step of vertically placing the sample on which the pure water has been dropped, and subsequently measuring a mass of the sample to examine an amount of the pure water stuck to the sample.

The electrode characteristic evaluation method includes a simple operation that includes, in a state in which a sample (which may be an electrode itself) taken from an electrode is horizontally placed, dropping pure water, subsequently vertically placing the sample for a time, and measuring a mass of the sample. This method does not require the dedicated device described above and can be easily carried out. Accordingly, a reduction in the operation time and a reduction in the cost can also be expected. The electrode characteristic evaluation method can quantitatively evaluate whether hydrophilicity of the electrode to an electrolyte is good or not for the reasons described below.

In the case of a sample taken from an electrode that is in an appropriately hydrophilized state, dropped pure water easily sticks to the sample. When pure water sticks to a sample, a mass of the sample after the dropping becomes larger than a mass of the sample before the dropping by an amount of the pure water stuck. On the other hand, in the case of a sample taken from an electrode that is in an inappropriately hydrophilized state, dropped pure water is, for example, repelled and does not substantially stick to the sample. The change in mass of the sample before and after the dropping is very small, or the mass of the sample does not substantially change. The above electrode to which pure water easily sticks is considered to have good hydrophilicity. An electrolyte easily permeates into such an electrode having good hydrophilicity, and a battery reaction can be satisfactorily performed. Thus, the use of such an electrode having good hydrophilicity in a storage battery such as a redox flow battery enables the internal resistance to decrease. Accordingly, the change in mass of the sample before and after the dropping can be used as a parameter for determining whether the hydrophilized state is good or not.

As described above, according to the electrode characteristic evaluation method, a characteristic such as hydrophilicity of an electrode to an electrolyte can be simply and accurately evaluated.

In addition, whether hydrophilicity of an electrode is good or not can be easily determined by using the electrode characteristic evaluation method. Therefore, for example, in the case of the construction of a redox flow battery (RF battery) that includes a plurality of pairs of positive electrodes and negative electrodes, the sticking ratio is measured for each electrode, and electrodes having high sticking ratios can be easily selected as non-defective electrodes. Alternatively, for example, in the case of the construction of an RF battery including electrodes each having a large area, the sticking ratios in a plurality of regions are measured for one electrode, and electrodes having high sticking ratios in all the regions can be easily selected as non-defective electrodes. An RF battery can be constructed by using only the selected non-defective electrodes. Accordingly, the electrode characteristic evaluation method can contribute to the construction of a storage battery, such as an RF battery, having a low internal resistance. The use of only the non-defective electrodes can provide a storage battery, such as an RF battery that can satisfactorily maintain for a long time a state in which the battery characteristics are easily stabilized and the internal resistance is low.

(2) A redox flow battery (RF battery) according to an embodiment of the present invention is a redox flow battery including at least one pair of electrodes in a stacked manner, the electrodes including a positive electrode and a negative electrode to which an electrolyte is supplied and in which a battery reaction is performed,

in which a total area of the electrodes is 40,000 cm² or more, and

a sticking ratio is 1% or more, the sticking ratio being a value determined by, in a state in which a sample taken from an arbitrary position of the stacked electrodes and having a predetermined size is horizontally placed, dropping a predetermined amount of pure water from above the sample, vertically placing the sample on which the pure water has been dropped, subsequently measuring a mass of the sample, and dividing an amount calculated by subtracting, from the measured value, a mass of the sample before the dropping by a mass of the dropped pure water.

The term “total area of electrodes” refers to an area determined by the product of the number of stacked electrodes and an area of one surface of one electrode, the surface oriented in a stacking direction.

The RF battery described above has a large total area of electrodes and thus is a high-output battery. In addition, the positive and negative electrodes of the RF battery each have a high sticking ratio of 1% or more, and thus the RF battery includes electrodes having good hydrophilicity. Accordingly, the above RF battery can be used as a battery in which a battery reaction can be satisfactorily performed, which has a low internal resistance, and which can maintain a high output for a long time. Furthermore, since all the electrodes included in the RF battery satisfy a sticking ratio of 1% or more, it is expected that a state in which the battery characteristics are easily stabilized and the internal resistance is low can be satisfactorily maintained for a long time compared with a case where the RF battery includes an electrode having a sticking ratio of less than 1%.

(3) In an embodiment of the RF battery, a variation in the sticking ratio in the positive electrode and a variation in the sticking ratio in the negative electrode are each 5% or less.

In the case where the above embodiment is a multi-cell battery, the sticking ratio of a positive electrode group is substantially uniform, and the sticking ratio of a negative electrode group is substantially uniform. In the case where the above embodiment is a single-cell battery or the like including electrodes each having a large area, the sticking ratio is substantially uniform over the whole of the positive electrode, and the sticking ratio is substantially uniform over the whole of the negative electrode. The embodiment having such a configuration has a small variation in the quality of the electrodes and thus the RF battery is expected to have good battery characteristics (in particular, a low internal resistance) for a long time.

(4) In an embodiment of the RF battery, the sticking ratio is 95% or more.

In the case where the above embodiment is a multi-cell battery, the sticking ratio of a positive electrode group is sufficiently high, and the sticking ratio of a negative electrode group is sufficiently high. In the case where the above embodiment is a single-cell battery or the like including electrodes each having a large area, the sticking ratio is sufficiently high over the whole of the positive electrode, and the sticking ratio is sufficiently high over the whole of the negative electrode. Accordingly, the above embodiment can be used as a high-output battery in which a battery reaction can be more satisfactorily performed and which has a lower internal resistance. Furthermore, in the above embodiment, since the variation in the sticking ratio in each of the positive and negative electrodes is 5% or less, the RF battery includes electrodes having a high quality and small variation in the quality. Thus, the RF battery is expected to have more satisfactory battery characteristics (in particular, a lower internal resistance) for a long time.

(5) An electrode for a redox flow battery (RF battery) according to an embodiment of the present invention is an electrode for a redox flow battery, the electrode being used in a redox flow battery to which an electrolyte is supplied and in which a battery reaction is performed,

in which the electrode has an area of 500 cm² or more, and

a sticking ratio is 1% or more, the sticking ratio being a value determined by, in a state in which a sample taken from an arbitrary position of the electrode and having a predetermined size is horizontally placed, dropping a predetermined amount of pure water from above the sample, vertically placing the sample on which the pure water has been dropped, subsequently measuring a mass of the sample, and dividing an amount calculated by subtracting, from the measured value, a mass of the sample before the dropping by a mass of the dropped pure water.

The term “area” refers to an area of one surface of a sheet-like electrode or an opposing surface thereof, the one surface or opposing surface facing an electrode of one pole when the sheet-like electrode is assembled as an electrode of the other pole in an RF battery.

The electrode for an RF battery has a large area and thus is used in a high-output battery. The electrode for an RF battery has a high sticking ratio, that is, 1% or more and has good hydrophilicity. Accordingly, when the electrode for an RF battery is used in an RF battery, it is possible to construct an RF battery in which a battery reaction can be satisfactorily performed, which has a low internal resistance, and which can maintain a high output for a long time. Furthermore, since the electrode for an RF battery satisfies a sticking ratio of 1% or more substantially over the entire region thereof, the electrode is expected to be capable of constructing an RF battery that can satisfactorily maintain for a long time a state in which characteristics are easily stabilized and the internal resistance is low compared with a case where the electrode includes a region having a sticking ratio of less than 1%.

### DETAILS OF EMBODIMENTS OF THE PRESENT INVENTION

Hereafter, a redox flow battery (RF battery) according to an embodiment of the present invention, an electrode for an RF battery according to an embodiment of the present invention, and an electrode characteristic evaluation method according to an embodiment of the present invention will be described in detail with reference to the drawings as required. The same reference signs in the drawings denote the same parts.

### Embodiment 1

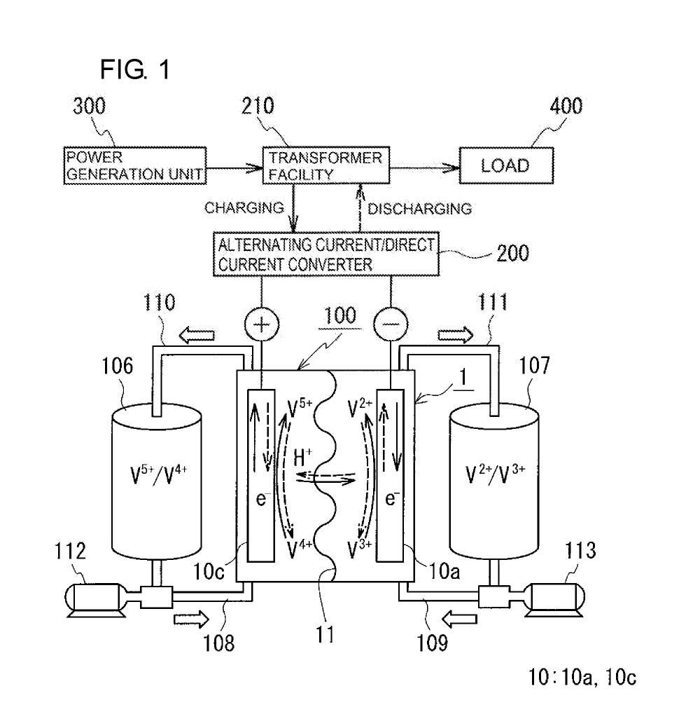

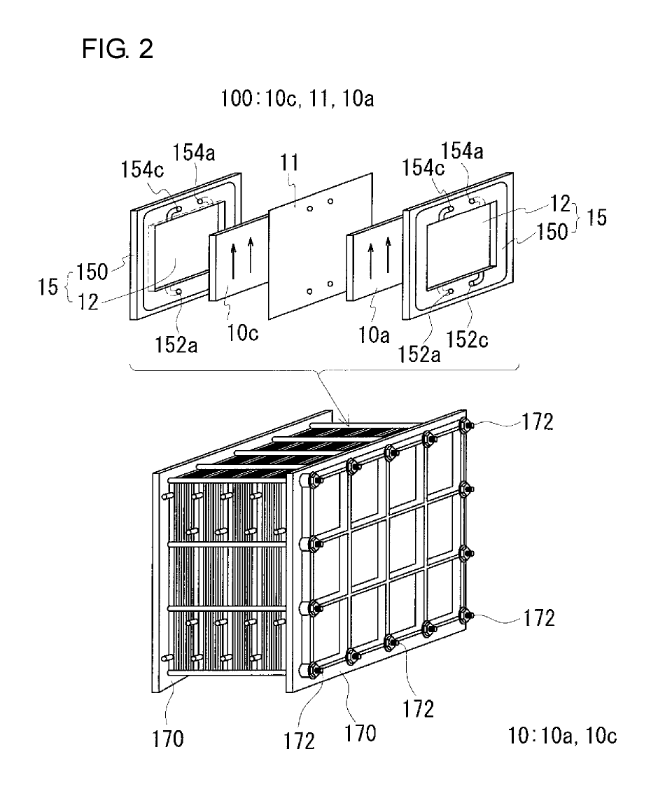

First, the overview of an RF battery 1 of Embodiment 1 and the overview of an RF battery system including the RF battery 1 will be described with reference to FIGS. 1 and 2. In FIG. 1, ions in a positive electrode tank 106 and a negative electrode tank 107 illustrate an example of ion species contained in electrolytes for electrodes. In FIG. 1, the solid-line arrows indicate charging, and the broken-line arrows indicate discharging.

### (Overview of RF Battery)

The RF battery 1 of Embodiment 1 is used by constructing an RF battery system including a circulation mechanism that circulates and supplies electrolytes to the RF battery 1 illustrated in FIG. 1. The RF battery 1 is typically connected, through an alternating current/direct current converter 200, a transformer facility 210, and the like, to a power generation unit 300 and a load 400 such as a power system or a consumer. The RF battery 1 performs charging by using the power generation unit 300 as a power supply source and performs discharging to the load 400 as a power supply target. Examples of the power generation unit 300 include solar power generation apparatuses, wind power generation apparatuses, and other general power plants.

### (Basic Configuration of RF Battery)

The RF battery 1 includes, as a main component, a battery cell 100 including a positive electrode 10c to which a positive electrode electrolyte is supplied, a negative electrode 10a to which a negative electrode electrolyte is supplied, and a membrane 11 disposed between the positive electrode 10c and the negative electrode 10a. The RF battery 1 is a multi-cell battery that includes one or more pairs of electrodes including a positive electrode 10c and a negative electrode 10a to which electrolytes are supplied and in which a battery reaction is performed, or a single-cell battery that includes one pair of electrodes 10c and 10a. The multi-cell battery includes a bipolar plate 12 (FIG. 2) between adjacent battery cells 100.

Each of the electrodes 10 included in the RF battery 1 is a reaction site to which an electrolyte containing an active material is supplied and in which the active material (ions) in the electrolyte causes a battery reaction, and is formed of a porous body so that the electrolyte can flow therethrough.

The membrane 11 is a separation member that separates positive and negative sections, the separation member separating the positive electrode 10c and the negative electrode 10a from each other and allowing predetermined ions to permeate therethrough.

The bipolar plate 12 is a flat plate-like member having front and back surfaces that are sandwiched between the positive electrode 10c and the negative electrode 10a and is a conductive member that conducts an electric current but does not allow electrolytes to flow therethrough. The bipolar plate 12 is typically used in a state of a frame assembly 15 including a frame 150 disposed on the outer periphery of the bipolar plate 12, as illustrated in FIG. 2. The frame 150 has liquid supply holes 152c and 152a through which electrolytes for electrodes are supplied to the electrodes 10 disposed on the bipolar plate 12 and liquid drainage holes 154c and 154a through which the electrolytes for the electrodes are discharged, the liquid supply holes 152c and 152a and the liquid drainage holes 154c and 154a being opened on front and back surfaces of the frame 150.

The RF battery 1 of this example is a multi-cell battery including a plurality of battery cells 100 and is a high-output battery having a total area of the plurality of electrodes 10 of 40,000 cm² or more. The plurality of battery cells 100 are stacked and used in the form of a cell stack. As illustrated in FIG. 2, the cell stack is formed by repeatedly stacking a bipolar plate 12 of a frame assembly 15, a positive electrode 10c, a membrane 11, a negative electrode 10a, a bipolar plate 12 of another frame assembly 15, and so on in this order. In the high-output RF battery 1, a sub-cell stack including a predetermined number of battery cells 100 may be prepared, and a plurality of sub-cell stacks may be stacked for use. FIG. 2 illustrates an example in which a plurality of sub-cell stacks are provided.

Current collector plates (not shown), instead of bipolar plates 12, are disposed on electrodes 10 located at both ends in the stacking direction of battery cells 100 in a sub-cell stack or a cell stack. End plates 170 are typically disposed on both ends in the stacking direction of battery cells 100 in a cell stack. A pair of end plates 170 are joined with joining members 172, such as long bolts, and integrated.

### (Overview of RF Battery System)

The RF battery system includes the RF battery 1 and a circulation mechanism described below (FIG. 1).

The circulation mechanism includes a positive electrode tank 106 that stores a positive electrode electrolyte to be circulated and supplied to the positive electrode 10c, a negative electrode tank 107 that stores a negative electrode electrolyte to be circulated and supplied to the negative electrode 10a, ducts 108 and 110 that connect the positive electrode tank 106 and the RF battery 1, ducts 109 and 111 that connect the negative electrode tank 107 and the RF battery 1, and pumps 112 and 113 that are respectively provided on the ducts 108 and 109 on the upstream side (supply side). By stacking a plurality of frame assemblies 15, liquid supply holes 152c and 152a and liquid drainage holes 154c and 154a constitute flow duct lines of electrolytes, and the ducts 108 to 111 are connected to the duct lines.

In the RF battery system, by using a positive electrode electrolyte circulation path including the positive electrode tank 106 and the ducts 108 and 110 and a negative electrode electrolyte circulation path including the negative electrode tank 107 and the ducts 109 and 111, the positive electrode electrolyte is circulated and supplied to the positive electrode 10c, and the negative electrode electrolyte is circulated and supplied to the negative electrode 10a. As a result of the circulation and supply, the RF battery 1 performs charging and discharging in response to valence change reactions of ions serving as active materials in the electrolytes for the electrodes. A known configuration can be appropriately used as the basic configuration of the RF battery system.

In the RF battery 1 of Embodiment 1, from a qualitative viewpoint, each of the electrodes 10c and 10a has good hydrophilicity, and from a quantitative viewpoint, a sticking ratio of pure water described below satisfies a particular range. The electrode 10 will now be described in more detail.

### (Electrode)

### <Material and Structure>

The electrode 10 is a sheet-like member formed of a porous body that contains, as a main component, a carbon material such as carbon fibers, graphite fibers, a carbon powder, carbon black, or carbon nano-tubes and that has a plurality of open pores. Carbon materials have, for example, good chemical resistance and oxidation resistance in addition to good electrical conductivity. Furthermore, hydrophilicity to electrolytes can be enhanced by subjecting a porous body that contains a carbon material as a main component to a hydrophilic treatment. Accordingly, a porous body that contains a carbon material as a main component and that has been subjected to a hydrophilic treatment or the like is suitable for an electrode 10 for which electrical conductivity, resistance to electrolytes, hydrophilicity to electrolytes, and the like are required. In general, the electrode 10 that has been subjected to a hydrophilic treatment has a hydrophilic group containing an oxygen atom. The amount (such as the number of atoms) of oxygen contained in the electrode 10 can be measured by using, for example, X-ray photoelectron spectroscopy (refer to PTL 1).

Specific examples of the porous body that contains a carbon material as a main component include sheet-like fiber aggregates such as carbon felt, carbon paper, and carbon cloth; and other porous bodies such as carbon foam.

The positive electrode 10c and the negative electrode 10a of this example are each a sheet-like fiber aggregate and have been subjected to a hydrophilic treatment.

### <Shape>

The electrode 10 can have various planar shapes. FIG. 2 illustrates an example of rectangular (including square) electrodes 10c and 10a. Other examples of the planar shape of the electrode 10 include circles, ellipses, and polygons. In a multi-cell battery as described in this example, the electrodes 10 typically have the same shape and the same size.

### <Size>

A plurality of pairs of positive electrodes 10c and negative electrodes 10a included in the RF battery 1 of this example substantially have the same size. For example, the areas of surfaces S₁₀ of each of the positive electrodes 10c and the negative electrodes 10a, the surfaces S₁₀ facing each other (also functioning as surfaces that face a membrane 11), are substantially equal to each other. The total area of the surfaces S₁₀ of the plurality of positive electrodes 10c is 20,000 cm² or more. The total area of the surfaces S₁₀ of the plurality of negative electrodes 10a is 20,000 cm² or more and is equal to the above total area of the plurality of the positive electrodes 10c. The above-described total area of the plurality of electrodes 10 is the total area of the plurality of pairs of positive electrodes 10c and negative electrodes 10a. The total area of the plurality of electrodes 10 can be appropriately selected in accordance with the output of the RF battery 1.

### <Hydrophilicity>

One of features of the RF battery 1 of Embodiment 1 lies in that a sticking ratio determined by subjecting each of the electrodes 10c and 10a to a hydrophilicity test described below is 1% or more.

### <<Hydrophilicity Test>>

A sample having a predetermined size is taken from an arbitrary position of positive electrodes 10c and negative electrodes 10a that are stacked. In a state in which the resulting sample is horizontally placed, a predetermined amount of pure water is dropped from above the sample. The sample on which the pure water has been dropped is vertically placed, and a mass m1 of this sample is then measured. An amount (m1−m0) is calculated by subtracting, from the measured value (mass m1), a mass m0 of the sample before the pure water is dropped. This amount (m1−m0) is divided by a mass m2 of the dropped pure water, and a value ((m1−m0)/m2)×100 is determined. This value is defined as a sticking ratio (%). The details of the hydrophilicity test will be described in an electrode characteristic evaluation method.

When the RF battery 1 includes a plurality of pairs of positive electrodes 10c and negative electrodes 10a as in this example, in each of a case where a sample is taken from, among the stacked pairs of the electrodes 10c and 10a, a positive electrode 10c located at an arbitrary stacking position and a case where a sample is taken from, among the stacked pairs of the electrodes 10c and 10a, a negative electrode 10a located at an arbitrary stacking position, the sticking ratio of the sample satisfies 1% or more. That is, all the electrodes included in the RF battery 1 satisfy a sticking ratio of 1% or more. As described in a test example below, when the sticking ratio of each of the electrodes 10c and 10a is less than 1%, the internal resistance (which is equal to a cell resistance in the case of a single-cell battery) becomes high. The higher the sticking ratio, the more easily pure water sticks to a sample. Thus, the electrode 10 from which this sample has been taken has good hydrophilicity and maintains an appropriate hydrophilized state. In the RF battery 1 including the electrode 10 having a high sticking ratio, an electrolyte permeates easily, and a battery reaction can be satisfactorily performed. As a result, the internal resistance can be more reliably reduced. Accordingly, the sticking ratio is preferably 2% or more, 3% or more, and 20% or more. With a further increase in the sticking ratio, a variation (described below) in the sticking ratio in each of the electrodes 10c and 10a also decreases. Accordingly, the sticking ratio is more preferably 80% or more (variation: 20% or less) and 90% or more (variation: 10% or less), still more preferably 95% or more (variation: 5% or less), and particularly preferably 98% or more (variation: 2% or less). Since a total inspection is performed in which the sticking ratio is measured and the variation in the sticking ratio of each of the electrodes 10c and 10a is measured for all the electrodes 10 included in the RF battery 1, the RF battery 1 having high reliability for hydrophilicity is provided.

Even in the case where an electrode 10 located at an arbitrary stacking position satisfies a sticking ratio of 1% or more as described above, in some cases, the variation in the sticking ratio may be large in the comparison between the electrodes 10. Even in the case of a multi-cell battery, a small variation in the sticking ratio easily makes hydrophilicity and battery reactivity of each of the electrodes 10 uniform, and consequently, the internal resistance is expected to be easily lowered. Accordingly, preferably, each of the electrodes 10 satisfies a sticking ratio of 1% or more, the variation in the sticking ratio in the positive electrodes 10c satisfies 5% or less, and the variation in the sticking ratio in the negative electrodes 10a satisfies 5% or less. The variation in the sticking ratio in each of the electrodes 10c and 10a preferably satisfies 3% or less, 2% or less, 1.5% or less, and further 1% or less. The variation in the sticking ratio can be easily reduced by selecting electrodes on the basis of the magnitude of the sticking ratio using an electrode characteristic evaluation method described below, and constructing an RF battery 1 by using only electrodes 10 that have substantially the same sticking ratio.

The size of the sample used in the measurement of the sticking ratio can be appropriately selected within a range that does not affect the design dimensions of the electrode 10. The sample is cut from the electrode 10 in accordance with the selected size. The electrode 10 itself may be used as the sample. In particular, with regard to an unused RF battery 1 that has not yet been impregnated with an electrolyte, an electrode 10 itself extracted from an arbitrary stacking position may be used as a sample for the measurement of the sticking ratio. In this case, the electrode after the measurement of the sticking ratio can be used in the RF battery 1. This also applies to Embodiment 2 described below.

### (Production Method)

The electrode 10 can be produced by using a known production method. In particular, a hydrophilic treatment is conducted. Specific examples of the hydrophilic treatment include a heat treatment, a plasma method, a photochemical method (use of a mercury lamp, a laser beam, or the like), and an ion implantation method. Known conditions can be used as conditions for the hydrophilic treatment (refer to, for example, PTL 1). For example, heat treatment conditions are as follows.

(Atmosphere) Oxygen-containing atmosphere such as air atmosphere
(Heating temperature) About 500° C. or higher and about 700° C. or lower
(Holding time) About 20 minutes or more and about 8 hours or less

The conditions for the hydrophilic treatment are preferably adjusted so that a decrease in the mass after the hydrophilic treatment is decreased to a certain extent. Specifically, an amount (M−M1) is calculated by subtracting a mass M1 of an electrode after the hydrophilic treatment from a mass M0 of the electrode before the hydrophilic treatment. The amount (M−M1) is divided by the mass M0 before the hydrophilic treatment, and a value ((M−M0/M0)×100 is determined. This value is defined as a mass loss ratio (%). In this case, the mass loss ratio is preferably 70% or less (also refer to a test example described below). This is because, in an electrode having a high mass loss ratio, battery reactivity degrades, and the internal resistance tends to increase because, for example, a carbon material is subjected to thermal denaturation or the like, resulting in a decrease in a conductive component. The mass loss ratio is preferably 65% or less, 60% or less, and 50% or less, more preferably 20% or less and 10% or less, particularly preferably 5% or less, and ideally 0% (not decreased). In the case where a heat treatment is conducted as the hydrophilic treatment, an excessively high heating temperature and an excessively long holding time tend to increase the mass loss ratio.

### (Other Members of RF Battery)

The bipolar plate 12 is formed of, for example, a conductive plastic that is a conductive material having a low electrical resistance, that does not react with electrolytes and that has resistance to electrolytes (chemical resistance, acid resistance, and the like).

The frame 150 is formed of, for example, a resin having good resistance to electrolytes and good electrical insulation properties.

Examples of the membrane 11 include ion-exchange membranes such as cation-exchange membranes and anion-exchange membranes.

### (Electrolyte)

The electrolyte used in the RF battery 1 contains active material ions, such as metal ions and non-metal ions. Examples of the electrolyte used in the RF battery 1 include a V-based electrolyte containing vanadium (V) ions having different valences (FIG. 1) as a positive electrode active material and a negative electrode active material. Examples of other electrolytes include an Fe—Cr electrolyte containing iron (Fe) ions as a positive electrode active material and chromium (Cr) ions as a negative electrode active material and a Mn—Ti electrolyte containing manganese (Mn) ions as a positive electrode active material and titanium (Ti) ions as a negative electrode active material. As the electrolyte, for example, an aqueous solution containing, in addition to the active materials, at least one acid or acid salt selected from the group consisting of sulfuric acid, phosphoric acid, nitric acid, hydrochloric acid, and salts thereof can be used.

### (Advantages)

While the RF battery 1 of Embodiment 1 is a high-output battery including a plurality of pairs of positive electrodes 10c and negative electrodes 10a, the RF battery 1 of Embodiment 1 has a low internal resistance because the sticking ratio of pure water in each of the electrodes 10c and 10a is 1% or more, and each cell includes electrodes 10 having good hydrophilicity. For example, an RF battery 1 having an internal resistance of 1 Ω·cm² or less can be provided. This advantage will be specifically described in Test Example 1. Furthermore, according to this RF battery 1, all the electrodes 10 included therein have a high sticking ratio, and preferably, the variation in the sticking ratio is also small. Accordingly, the RF battery 1 is expected to be capable of providing a high output while satisfactorily maintaining for a long time a state in which the battery characteristics are easily stabilized and the internal resistance is low. In addition, according to the RF battery 1 of Embodiment 1, whether the characteristic is good or not can be easily grasped, and thus a reduction in the cost can also be expected in this respect.

### Embodiment 2

An RF battery of Embodiment 2 is a single-cell battery including a single battery cell 100 and is a high-output battery including large electrodes. More specifically, the area of a surface S₁₀ of a positive electrode 10c, the surface S₁₀ facing a negative electrode 10a, and the area of a surface S₁₀ of a negative electrode 10a, the surface S₁₀ facing a positive electrode 10c, are each 500 cm² or more. In addition, the RF battery of Embodiment 2 satisfies a sticking ratio of pure water of 1% or more, the sticking ratio being determined by conducting the hydrophilicity test for a sample having a predetermined size and taken from an arbitrary position of each of the electrodes 10c and 10a. Regarding this electrode 10, a portion having a low sticking ratio is not locally present, and substantially the entire region satisfies a sticking ratio of 1% or more.

The higher the sticking ratio, the better the hydrophilicity and the smaller the variation, as described above. The sticking ratio is preferably 2% or more, 3% or more, 20% or more, 80% or more, and 90% or more, more preferably 95% or more, and particularly preferably 98% or more. The variation of the sticking ratio, the variation being determined by comparing the amounts at different measurement positions, is preferably 5% or less, 3% or less, 2% or less, and 1.5% or less, and more preferably 1% or less.

When the sample used for the measurement of the sticking ratio is, for example, an electrode 10 itself, the electrode 10 may be virtually divided into a plurality of regions each having a predetermined size, and pure water may be dropped on each of the small regions to measure the sticking ratio. In this manner, it is possible to easily measure whether or not the sticking ratio is at least 1% substantially over the entire region. For example, in the case where the dropping is performed by using a micropipette or the like, an operation of shifting the dropping position for every predetermined length enables the dropping in each region to be easily performed. In addition, when the holding time during which the sample is vertically placed after the dropping is extremely short as described below and the mass m1 is then measured, this mass can be considered to be the mass for each small region. With regard to an unused RF battery that has not yet been impregnated with an electrolyte, the sticking ratio in each small region is measured as described above, and the electrode after the measurement of the sticking ratio can be used in the RF battery.

The electrode 10 in which the surface S₁₀ has a large area of 500 cm² or more whereas the sticking ratio satisfies 1% or more substantially over the entire region thereof and, preferably, the variation in the sticking ratio is also small is obtained by, for example, appropriately conducting a hydrophilic treatment, and then keeping the resulting electrode 10 so that the hydrophilized state does not change during storage, transportation, and the like.

While the RF battery of Embodiment 2 is a high-output battery including one pair of a large positive electrode 10c and a large negative electrode 10a, the RF battery of Embodiment 2 has a low internal resistance because the sticking ratio of pure water at any position in each of the electrodes 10c and 10a is 1% or more, and the RF battery includes electrodes 10 having good hydrophilicity substantially over the entire region thereof. Furthermore, as described above, according to this RF battery, each of the electrodes 10c and 10a has a high sticking ratio substantially over the entire region thereof, and preferably, the variation in the sticking ratio is also small. Accordingly, the RF battery is expected to be capable of providing a high output while satisfactorily maintaining for a long time a state in which the battery characteristics are easily stabilized and the internal resistance is low.

### (Electrode Characteristic Evaluation Method)

Next, an electrode characteristic evaluation method of Embodiment 1 will be described.

The electrode characteristic evaluation method of Embodiment 1 is used when a characteristic of an electrode used in a storage battery including an electrolyte is evaluated, the storage battery being, for example, a storage battery including an electrolyte that contains an active material and typified by the above RF batteries 1 of Embodiments 1 and 2. This characteristic is hydrophilicity with the electrolyte in the electrode. In the electrode characteristic evaluation method of Embodiment 1, hydrophilicity is quantitatively evaluated by using, as an index of hydrophilicity to an electrolyte, an amount of a liquid that permeates and sticks to an electrode when the liquid is dropped on a sample taken from the electrode.

Specifically, the electrode characteristic evaluation method of Embodiment 1 includes a dropping step of, in a state in which a sample taken from an electrode and having a predetermined size and a mass m0 is horizontally placed, dropping a predetermined amount (mass: m2) of pure water from above the sample; and a measurement step of, after the sample on which the pure water has been dropped is vertically placed, measuring a mass m1 of the sample to measure an amount (m1−m0) of pure water stuck to the sample.

A larger amount of sticking (m1−m0) and a larger value calculated by using the amount of sticking (m1−m0), for example, a larger value of the sticking ratio described above ((m1−m0)/m2)×100(%) mean that pure water easily sticks to the sample, and the electrode 10 from which the sample has been taken has good hydrophilicity and maintains an appropriate hydrophilized state. In the case where the evaluation is performed by using the sticking ratio (%), an electrode having a sticking ratio of 1% or more is determined to have good hydrophilicity as described above. Each of the steps will now be described in detail.

### <Dropping Step>

### <<Taking of Sample>>

A sample for the measurement may be taken from an electrode before the electrode is assembled in a storage battery such as an RF battery. In this case, only “non-defective electrodes” having a high sticking ratio or the like and good hydrophilicity are used in a storage battery such as an RF battery to thereby construct a storage battery having a low internal resistance.

Alternatively, in the case of the construction of a multi-cell battery or a large battery, a plurality of electrodes each having a size that includes a margin in addition to predetermined design dimensions may be prepared. Samples having any size can be taken from such electrodes within a range that does not affect the predetermined design dimensions.

In the case where samples are prepared as described above, a total inspection can be performed, and reliability of the sticking ratio and reliability of the variation in the sticking ratio can be enhanced.

Alternatively, for example, in the case where the production conditions, the transportation state, the storage state, and the like of a plurality of electrodes produced in the same lot are considered to be the same, evaluation performed by using, as a sample, only an electrode arbitrarily extracted from the plurality of electrodes can be regarded as evaluation of the plurality of electrodes. That is, a sampling inspection can be performed. In the case of the sampling inspection, the evaluation of hydrophilicity can be conducted for a plurality of electrodes within a shorter time to achieve good workability. Also in this case, reliability of the sticking ratio and reliability of the variation in the sticking ratio can be enhanced by increasing the number of samples.

A sample can be taken from the electrode 10 included in a storage battery such as an RF battery 1. In this case, the sample may be an unused electrode that has not yet been impregnated with an electrolyte as described above. Furthermore, in this case, the electrode 10 itself included in the RF battery 1 or the like can be used as a sample as it is without cutting or the like. Alternatively, a hydrophilicity test can be conducted for a plurality of virtual small regions by using one electrode 10 as it is without cutting into small pieces. A total inspection can be easily conducted in this manner. The size of each of the small regions is, for example, 10% or less, 5% or less, and further 1% or less on the assumption that the area of the surface S₁₀ of the electrode 10 is 100%. In such a case, the variation in the sticking ratio described above can be measured with high accuracy.

The size of the sample can be appropriately selected. For example, a plate-like rectangular (including square) sample having a width of about 20 mm or more and 40 mm or less and a length of about 20 mm or more and 40 mm or less is easily handled.

### <<Arrangement of Sample>>

The plate-like sample taken as described above is arranged such that one surface thereof and an opposing surface thereof are horizontally disposed. The sample can be arranged on a horizontal base. Before the sample is horizontally arranged, the mass m0 (g) of the sample is measured in advance.

### <<Dropping of Pure Water>>

Commercially available pure water can be used as pure water dropped on the sample. The mass m2 (g) of the pure water dropped can be appropriately selected in accordance with the size of the sample or the size of the small regions that are virtually divided. For example, in the case of a sample having dimensions of 3 cm×3 cm, the mass m2 (g) is about 0.5 g.

The prepared pure water is dropped by using a micropipette or the like from above the sample that is horizontally arranged as described above. The dropping height from the sample can be appropriately selected in a range in which the dropping water can reliably contact the sample. An example of the height is about 1 mm or more and 50 mm or less. When the sample has good hydrophilicity, the dropped pure water, for example, sequentially permeates and sticks to the sample. When the sample has poor hydrophilicity, in other words, has good water repellency, water droplets accumulate on the surface of the sample.

### <Measurement Step>

### <<Vertical Placement of Sample>>

After the dropping of the prepared pure water is finished, the sample is vertically placed immediately. More specifically, the sample is allowed to stand such that one surface of the sample and an opposing surface thereof are disposed in parallel in the vertical direction. The holding time in this vertically standing state is very short and is, for example, about 1 second or more and 10 seconds or less. When the sample has good hydrophilicity, a large amount or substantially all of the pure water stuck to the sample remains at the stuck position and remains stuck. When the sample has poor hydrophilicity (has good water repellency), the water droplets accumulated on the surface of the sample are dropped by vertically placing the sample and do not stick to the sample.

### <<Measurement of Mass>>

After the sample is vertically placed as described above, the mass m1 of the sample is measured. The value (m1−m0) is determined by subtracting the mass m0 of the sample before the dropping from the mass m1 of the sample after the dropping. This value (m1−m0) corresponds to the amount of pure water stuck to the sample and is equal to or less than the mass m2 of the prepared pure water.

### (Evaluation Method)

A larger amount (m1−m0) of pure water stuck to the sample, which is closer to the mass m2 of the prepared pure water, means that a liquid such as an electrolyte permeates through the sample more easily and the sample has better hydrophilicity. A smaller amount (m1−m0) of pure water stuck to the sample means that the sample has poorer hydrophilicity. Therefore, the magnitude of the amount (m1−m0) of pure water stuck can be directly used to evaluate whether hydrophilicity is good or not. However, the magnitude of this amount (m1−m0) is affected by the magnitude of the mass m2 of the prepared pure water. In view of this, a value determined by dividing the amount (m1−m0) of pure water stuck to the sample by the mass m2 of the dropped pure water ((m1−m0)/m2)×100 is defined as a sticking ratio (%) of pure water, and this sticking ratio (%) is used as a parameter for evaluating whether hydrophilicity is good or not. For example, a sample that satisfies a sticking ratio of 1% or more is determined to be a non-defective electrode having good hydrophilicity, and a sample that has a sticking ratio of less than 1% is determined to be a defective electrode having poor hydrophilicity.

### (Use)

The electrode characteristic evaluation method of Embodiment 1 can be used to, for example, select only electrodes 10 having good hydrophilicity when a storage battery such as an RF battery 1 is constructed. Alternatively, the electrode characteristic evaluation method of Embodiment 1 can be used to confirm a characteristic of electrodes 10 prior to the operation with regard to a storage battery such as an unused RF battery 1 that has not yet been impregnated with an electrolyte.

### (Advantage of Characteristic Evaluation Method)

According to the electrode characteristic evaluation method of Embodiment 1, whether hydrophilicity of an electrode is good or not can be simply evaluated to easily select an electrode having good hydrophilicity. Therefore, for example, an RF battery 1 having a low internal resistance can be constructed by using the selected non-defective electrode. Accordingly, the electrode characteristic evaluation method of Embodiment 1 can contribute to the construction of a storage battery, such as an RF battery 1, having a low internal resistance, and preferably a storage battery, such as an RF battery 1, having a low internal resistance for a long time. Alternatively, by using the electrode characteristic evaluation method of Embodiment 1 for determining whether hydrophilicity of an electrode 10 included in an RF battery 1 or the like is good or not, for example, an RF battery 1 having a low internal resistance can be more reliably provided. In addition, since the electrode characteristic evaluation method of Embodiment 1 can be simply carried out within a short time, a reduction in the cost can also be expected in this respect.

### Test Example 1

A plurality of electrodes were prepared under different conditions for a hydrophilic treatment, and the sticking ratios of pure water were examined. RF batteries were constructed by using the prepared electrodes, and the inner resistances thereof were examined.

In this test, first, carbon felt having a thickness of 3 mm is prepared and subjected to a hydrophilic treatment under the conditions described below to prepare an electrode after treatment. A plate-like square sample having dimensions of 3 cm×3 cm is taken from the electrode after treatment and subjected to a hydrophilicity test described below to determine the sticking ratio (%) of pure water.

### (Hydrophilization Conditions)

| | |
|---|---|
| Atmosphere | air atmosphere |
| Heating temperature | selected from a range of 400° C. to 650° C. |
| Holding time | selected from a range of 20 minutes to 10 hours |

Sample No. 1-100 is a sample prepared under conditions in which the heating temperature is low and the holding time is short in the ranges described above. Sample No. 1-10 is a sample prepared under conditions in which the heating temperature is high and the holding time is long in the ranges described above. Sample Nos. 1-1 to 1-5 are samples prepared at a higher temperature for a longer time than Sample No. 1-100 and at a lower temperature for a shorter time than Sample No. 1-10. Regarding Sample Nos. 1-1 to 1-5, a sample having a smaller sample number satisfies at least one of a low temperature and a short holding time.

### (Hydrophilicity Test)

A mass m0 (g) of a sample is measured, and the sample is then arranged such that one surface (surface having dimensions of 3 cm×3 cm) of the sample and an opposing surface thereof are horizontally disposed. In the state in which the sample is horizontally placed, 0.5 g (=m2) of pure water is dropped with a micropipette from a position 5 mm above the sample. After the dropping, the sample is vertically placed (held for 5 seconds), and a mass m1 (g) of this sample is then measured. The value {(mass m1 (g) of sample after dropping−mass m0 (g) of sample before dropping)/mass m2 (g) of dropped pure water}×100 is determined. This value is defined as a sticking ratio (%) of pure water and shown in Table 1.

### (Mass Loss Ratio)

A plate-like square sample having dimensions of 15 cm×15 cm is taken from the carbon felt having a thickness of 3 mm, and a mass M0 (g) of the sample is measured. This sample is subjected to a hydrophilic treatment under the hydrophilization conditions described above to prepare an electrode after treatment. A mass M1 (g) of the electrode after treatment is measured. A value {(mass M0 (g) of sample before hydrophilic treatment−mass M1 (g) of sample after hydrophilic treatment)/mass M0 (g) of sample before hydrophilic treatment}×100 is determined. This value is defined as a mass loss ratio (%) of the sample and shown in Table 1.

### (Internal Resistance)

An RF battery (single-cell battery) including a single battery cell is constructed by using the sample (3 cm×3 cm) provided to the hydrophilicity test, and the internal resistance (which is the same as the cell resistance in this example, Ω·cm²) is measured. The results are shown in Table 1. In this test, a vanadium-based electrolyte containing vanadium ions and sulfuric acid is supplied to the single-cell battery, and an electric current is applied at a constant current density (70 A/cm²). The internal resistance is determined by using a cell voltage after a predetermined time passes and an electric current value at this time. A commercially available ion-exchange membrane (thickness: 55 μm) was used as a membrane.

TABLE 1

| Sample No. | 1-1 | 1-2 | 1-3 | 1-4 | 1-5 | 1-100 | 1-10 |
|---|---|---|---|---|---|---|---|
| Sticking ratio of pure | 2% | 21% | 98% | 98% | 98% | 0.2% | 98% |
| water | | | | | | | |
| Mass loss ratio | 0% | 0% | 1% | 16% | 48% | 0% | 73% |
| Internal resistance | 1.0 | 0.9 | 0.9 | 0.9 | 0.9 | 1.3 | 1.1 |
| (Ω · cm²) | | | | | | | |

As shown in Table 1, Sample Nos. 1-1 to 1-5 in which the sticking ratio of pure water is 1% or more each have a low internal resistance (cell resistance) when a storage battery such as an RF battery is constructed. In this test example, the internal resistances of Sample Nos. 1-1 to 1-5 are lower than that of Sample No. 1-100 in which the sticking ratio of pure water is low, that is, less than 1% by 0.3 Ω·cm² or more. One of the possible reasons why these results were obtained is that Sample Nos. 1-1 to 1-5 each had a high sticking ratio of pure water of 1% or more and had good hydrophilicity, and thus a battery reaction could be satisfactorily performed. Comparison of Sample No. 1-1 and Sample Nos. 1-2 to 1-5 shows that with an increase in the sticking ratio of pure water, the internal resistance tends to decrease.

As shown in Table 1, a high mass loss ratio of more than 70% results in a high internal resistance (cell resistance). In this test, the internal resistance of Sample No. 1-10 having a mass loss ratio of more than 70% is slightly lower than that of Sample No. 1-100. This result shows that the hydrophilic treatment is preferably conducted under the conditions in which the mass loss ratio is 70% or less.

In addition, the determination of the sticking ratio of pure water using the hydrophilicity test enables easy selection of, for example, an electrode having a sticking ratio of 1% or more, and furthermore electrodes having sticking ratios that are close to each other or electrodes having substantially the same sticking ratio. By using only the selected electrodes in an RF battery, even in, for example, a high-output RF battery including a plurality of pairs of positive electrodes and negative electrodes having a total area of 40,000 cm² or more, the sticking ratio is easily increased, and preferably, the variation in the sticking ratio is easily decreased (for example, the variation is 5% or less, 3% or less, and further 1% or less, and preferably substantially 0%). Alternatively, even in, for example, a high-output RF battery including electrodes each having a large area of 500 cm² or more, the sticking ratio is easily increased substantially over the entire region of each of the electrodes, and preferably, the variation in the sticking ratio is easily decreased (for example, the variation is 5% or less, 3% or less, and further 1% or less, and preferably substantially 0%). As a result, a multi-cell battery, a single-cell battery, or the like having good hydrophilicity and a low internal resistance can be constructed easily and accurately.

The above results show that an RF battery that includes an electrode having a high sticking ratio of pure water has a low internal resistance. The above results also show that the use of an electrode having a high sticking ratio of pure water enables an RF battery having a low internal resistance to be constructed. Furthermore, the above results show that the electrode evaluation method, in which the sticking ratio (%) of pure water is used to evaluate whether hydrophilicity of an electrode is good or not, can be used in the construction of a storage battery, such as an RF battery, having a low internal resistance.

The present invention is not limited to the examples described above. The scope of the present invention is defined by the appended claims and is intended to cover all modifications within the meaning and scope equivalent to those of the claims.

For example, a V-based electrolyte was used in Test Example 1. The electrolyte may be changed to a Ti—Mn electrolyte, an Fe—Cr electrolyte, or another electrolyte. Carbon felt was used as electrodes in Test Example 1. The electrode may be changed to carbon paper, carbon cloth, carbon foam, or the like.

### INDUSTRIAL APPLICABILITY

The redox flow batteries according to the present invention can be used for storage batteries, with respect to natural energy power generation, such as solar power generation or wind power generation, for the purpose of stabilizing fluctuation of power output, storing generated power during oversupply, leveling load, and the like. Furthermore, the redox flow batteries according to the present invention can be additionally placed in an ordinary power plant and used as storage batteries as countermeasures against voltage sag/power failure and for the purpose of leveling load. The electrode for a redox flow battery according to the present invention can be used as a component of a redox flow battery. The electrode characteristic evaluation method according to the present invention can be used to evaluate whether a characteristic of an electrode is good or not, the electrode being included in a storage battery that uses an electrolyte, such as the redox flow battery described above.

Reference Signs List

| 1 redox flow battery (RF battery) | | 10 electrode | |
|---|---|---|---|
| 10c positive electrode | 10a negative electrode | 11 membrane | 12 bipolar plate |

100 battery cell

| 15 frame assembly | 150 frame | | |
|---|---|---|---|
| 152c, 152a liquid supply hole | | 154c, 154a liquid drainage hole | |
| 170 end plate | 172 joining member | | |
| 106 positive electrode tank | 107 negative electrode tank | | 108 to 111 duct |
| 112, 113 pump | | | |

| | | |
|---|---|---|
| 200 alternating current/direct current converter | 210 transformer facility | 300 power generation unit |

400 load

1. An electrode characteristic evaluation method for evaluating a characteristic of an electrode used in a storage battery including an electrolyte, the method comprising:
a step of, in a state in which a sample taken from the electrode and having a predetermined size is horizontally placed, dropping a predetermined amount of pure water from above the sample; and
a step of vertically placing the sample on which the pure water has been dropped, and subsequently measuring a mass of the sample to examine an amount of the pure water stuck to the sample.

2. A redox flow battery comprising at least one pair of electrodes in a stacked manner, the electrodes including a positive electrode and a negative electrode to which an electrolyte is supplied and in which a battery reaction is performed,
wherein a total area of the electrodes is 40,000 cm² or more, and
a sticking ratio is 1% or more, the sticking ratio being a value determined by, in a state in which a sample taken from an arbitrary position of the stacked electrodes and having a predetermined size is horizontally placed, dropping a predetermined amount of pure water from above the sample, vertically placing the sample on which the pure water has been dropped, subsequently measuring a mass of the sample, and dividing an amount calculated by subtracting, from the measured value, a mass of the sample before the dropping by a mass of the dropped pure water.

3. The redox flow battery according to claim 2, wherein a variation in the sticking ratio in the positive electrode and a variation in the sticking ratio in the negative electrode are each 5% or less.

4. The redox flow battery according to claim 2 or 3, wherein the sticking ratio is 95% or more.

5. An electrode for a redox flow battery, the electrode being used in a redox flow battery to which an electrolyte is supplied and in which a battery reaction is performed,
wherein the electrode has an area of 500 cm² or more, and
a sticking ratio is 1% or more, the sticking ratio being a value determined by, in a state in which a sample taken from an arbitrary position of the electrode and having a predetermined size is horizontally placed, dropping a predetermined amount of pure water from above the sample, vertically placing the sample on which the pure water has been dropped, subsequently measuring a mass of the sample, and dividing an amount calculated by subtracting, from the measured value, a mass of the sample before the dropping by a mass of the dropped pure water.
